(19) United States
(12) Patent Application Publication
(10) Pub. No.: US 2009/0185173 A1
(43) Pub. Date: Jul. 23, 2009

(54) APPARATUS AND METHOD FOR DETERMINING CHARACTERISTICS OF A LIGHT SOURCE

(75) Inventors: Ian Ashdown, West Vancouver (CA); Marc Salsbury, Battersea (CA)

Correspondence Address: Philips Intellectual Property and Standards, P.O. Box 3001, Briarcliff Manor, NY, 10510-8001, US

(73) Assignee: TIR TECHNOLOGY LP, Burnaby (CA)

(21) Appl. No.: 12/303,023

(22) PCT Filed: Jun. 1, 2007
(86) PCT No.: PCT/CA07/00972

§ 371 Date: Dec. 1, 2008

Related U.S. Application Data
(60) Provisional application No. 60/833,896, filed on Jul. 28, 2006.

(30) Foreign Application Priority Data
Jun. 5, 2006 (CA) 2549560

(51) Int. Cl. G01J 1/00

(52) U.S. Cl. 356/121

(57) ABSTRACT

The invention provides an apparatus for sampling and determining characteristics of a light source. The apparatus comprises a sensor system configured to sample the spatial and spectral radiation characteristics of the light source and a goniometer that is configured to desirably control and adjust the relative position between the sensor system and the light source. The goniometer is configured to position the sensor system relative to the light source using two or more degrees of freedom. The apparatus additionally includes a control system configured to control the operation of the sensor system and the sampling of the spatial and spectral radiation characteristics of the light source. The control system is further configured to control operation of the goniometer for the relative positioning of the sensor system and the light source.

### FIELD OF THE INVENTION

The present invention pertains to radiometry and in particular to a system for determining the spatial and spectral radiation characteristics of a light source.

### BACKGROUND

Luminaires can be more effective if the characteristics of light sources and optical systems of the luminaire are adequately matched. Adequate matching, however, often requires accurate knowledge of the spatial and spectral radiation characteristics of a light source, particularly when the distance between the light source and optical components such as lenses and reflectors are comparable to the width of the light source.

Different details of information of the radiation characteristics of a light source can be expressed by, for example, a plenoptic function as disclosed by Adelson E. et al. in “The plenoptic function and the elements of early vision”, Computation Models of Visual Processing, MIT Press (1991). The amount of information which is required to adequately describe a light source for the purpose of modelling a luminaire can vary greatly. Based on a model description of the light source, the plenoptic function can be inferred, for example, by first principle calculations or empirical approximations. The plenoptic function can also be experimentally determined by measuring the spatial and spectral radiation characteristics of a real light source under desired operating conditions.

Practical purposes determine at which minimal distance in a certain direction the light emitted by a light source may be approximated to appear to originate from a single point in space. Beyond these distances the intricacies of the radiation characteristics due to the finite extension of a light source can be neglected for the specific practical purposes. This is manifested in many luminous and radiant flux modelling and measuring techniques which apply a so called point source or far-field approximation. While near-field radiation characteristics can in some cases be approximated from measured far-field radiation characteristics, the approximations are rarely adequate for subsequent optical design of luminaries employing the light source.

For example, International Patent Application Publication No. WO83/02003 discloses a method of and means for measuring intensities of illumination across a light beam using a photometer to measure light intensities of areas across the beam. The light source is positioned at a defined distance from the photometer and a mechanism is used to sweep the light source across the photometer progressively or incrementally at different angles of elevation or depression or by using an array of stacked photometers to record a series of points or graphs of the scan.

U.S. Pat. No. 5,949,354 discloses a goniometric scanning radiometer with multiple mirrors to fold the optical path from the light source to a radiometric sensor to achieve a more compact device design. The disclosed radiometer performs far-field radiometric measurements. The patent also discloses how to use a camera to perform near-field radiometric measurements.

These techniques, however, cannot provide reliable characterizations of the near-field radiation characteristics of a light source. Consequently, such techniques provide insufficient information to accurately describe light sources under other than far-field conditions.

U.S. Pat. No. 5,253,036 discloses that each photosensitive element of a digital camera sensor can sense the luminance of a directed ray of light which can be traced back to a specific location of an extended areal or volumetric light source. The patent describes a method and an apparatus to calculate the four-dimensional luminance field L(θ,φ,σ,ω) by processing photometrically calibrated digital images of the light source which are taken from a number of different view points. The patent further describes how to interpolate the luminance field for arbitrary view points and how to calculate the illuminance at an arbitrary point of a surface by interpolating the sampled four-dimensional luminance data. The invention, however, cannot provide accurate spectral resolution for all types of light sources and it can only, at best, infer information about the distance between the sensor and the light source.

U.S. Pat. No. 6,982,744 discloses a multi-point calibration method for an imaging light and color measurement device. A light-emitting surface has a plurality of light-emitting areas and the luminance or color of each light-emitting area of the light emitting surface at a specific angle is measured using a spot measurement instrument. By aligning the spot measurement instrument with one of the light-emitting areas at a time, the luminance or color of the light-emitting areas of the light-emitting surface is measured. A measurement of the light-emitting surface is made with the imaging light and color measurement device. A matrix of correction factors is calculated to correct the areas as measured by the imaging light and color measurement device to be equivalent to those measured by the spot photometer. While a display device is measured by the imaging light and color measurement device, its measured luminance or color values are corrected by the screen gain correction matrix. The invention requires cumbersome light filtering before image capture. It also cannot sufficiently resolve the spectral power distribution (SPD) of narrowband light sources nor does it provide information about the distance between the sensor and the light source.

Therefore there is a need for a new method and apparatus for evaluating spatial and spectral radiation characteristics of a light source.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the invention is to provide an apparatus and method for determining characteristics of a light source. In accordance with an aspect of the invention, there is provided an apparatus for sampling light source characteristic data, the apparatus comprising: a sensor system including one or more image sensors configured to collect light source characteristic data; a goniometer operatively coupled to the sensor system and the light source, the goniometer configured to control relative position between the sensor system and light source, the goniometer comprising two or more degrees of freedom for relative positioning of the sensor system and the light source; and a control system configured to control operation of the goniometer to control the relative position between the light source and the sensor system, the control system further configured to control the sensor system for acquisition of the spectral radiation characteristics, wherein the control system captures light source characteristic data which is indicative of spatial and spectral characteristic of the light source as defined by the relative position of the light source and the sensor system.

In accordance with another aspect of the invention, there is provided a method for sampling spatial and spectral radiation characteristics of a light source, the method comprising the steps of: disposing and aligning the light source; positioning a sensor system relative to the light source thereby defining a first relative position and orientation of the sensor system to the light source; acquiring first light source characteristic data from the sensor system, the first light source characteristic data indicative of the spatial and spectral radiation characteristics of the light source in the first relative position; recording the first light source characteristic data and the first relative position and orientation, determining a second relative position and orientation of the sensor system to the light source; positioning the sensor system and the light source at the second relative position and orientation of the sensor system to the light source; acquiring second light source characteristic data from the sensor system, the second light source characteristic data indicative of the spatial and spectral radiation characteristics of the light source in the first relative position; recording the second light source characteristic data and the second relative position and orientation.

### BRIEF DESCRIPTION OF THE FIGURES

FIG. 1 illustrates a principal view of an apparatus for determining characteristics of a light source, according to an embodiment of the invention.

FIG. 2 illustrates a principal view of an optical path from a light source to a sensor system, according to an embodiment of the invention.

FIG. 3A illustrates an icosahedron for defining sampling coordinates according to an embodiment of the invention.

FIG. 3B illustrates a first generation subdivision of the icosahedron of FIG. 3A.

FIG. 3C illustrates a second generation subdivision of the icosahedron of FIG. 3A.

FIG. 3D illustrates a third generation subdivision of the icosahedron of FIG. 3A.

FIG. 4 illustrates a principal view of an optical path from a light source to a sensor system, according to one embodiment of the invention, and illustrating a correspondence between an element of the surface of the light source and a photosensitive element.

FIG. 5 illustrates a ray interpolation principle utilizing information from a set of three calibrated images, according to an embodiment of the invention.

FIG. 6A illustrates a photograph of a light-emitting diode (LED) die under operating conditions, taken using an apparatus according to the invention.

FIG. 6B illustrates a photograph of an encapsulated LED die under operating conditions, taken using an apparatus according to the invention.

### DETAILED DESCRIPTION OF THE INVENTION

### Definitions

The term “light source” is used to define a source of electromagnetic radiation which is within the visible or near visible wavelength range, for example one or a combination of the infrared wavelength range, visible wavelength range or ultraviolet wavelength range. Examples of a light source include but are not limited to incandescent lights, fluorescent lights, halogen lights, candles, light-emitting diodes, semiconductor light emitting diodes, organic light-emitting diodes and the like.

As used herein, the term “about” refers to a +/−10% variation from the nominal value. It is to be understood that such a variation is always included in any given value provided herein, whether or not it is specifically referred to.

Unless defined otherwise, all technical and scientific terms used herein have the same meaning as commonly understood by one of ordinary skill in the art to which this invention belongs.

The invention provides an apparatus for sampling and determining characteristics of a light source. For example the apparatus can sample the radiation characteristics of the light source and may determine its plenoptic function. The apparatus can be used to determine the radiation characteristics of a light source from within a wide range of distances from the light source and at a wide range of angles to the light source including a near-field range. The near-field radiation characteristics of a light source can be important, for example, when determining certain aspects of diffractive micro-optical structures for light-emitting diode based luminaires. The invention further provides for the evaluation of light source radiation characteristics at desired locations outside of the light source through the processing and interpolating of measured light source characteristics.

The apparatus for determining characteristics of a light source comprises a sensor system configured to sample the spatial and spectral radiation characteristics of the light source and a goniometer that is configured to desirably control and adjust the relative position between the sensor system and the light source. The goniometer is configured to position the sensor system relative to the light source using two or more degrees of freedom. The apparatus additionally includes a control system configured to control the operation of the sensor system and the sampling of the spatial and spectral radiation characteristics of the light source. The control system is further configured to control operation of the goniometer for the relative positioning of the sensor system and the light source. Optionally the control system can be configured to control the operating conditions of the light source and may optionally be configured to perform analysis of the light source characteristic data collected by the sensor system.

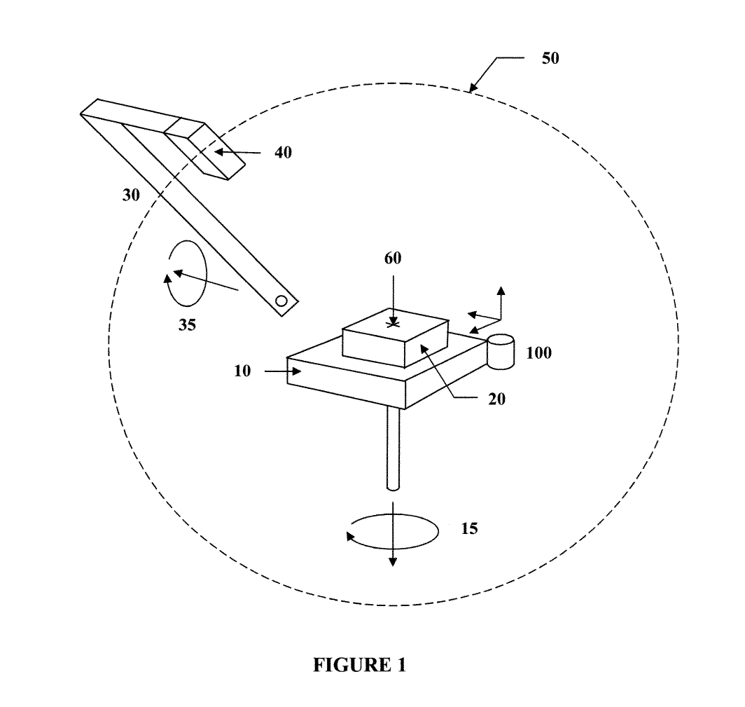

FIG. 1 illustrates a principal view of the setup of an apparatus for determining characteristics of a light source according to an embodiment of the invention. The apparatus comprises a goniometer with a mounting stage 10 and a rotating arm 30. The mounting stage 10 has at least one degree of freedom including the positioning at a desired first angle by rotation about a first axis 15. The arm 30 has at least one degree of freedom including the positioning at a desired second angle by rotation about a second axis 35. The first axis 15 intersects the second axis 35 at normal angle. The apparatus further comprises a sensor system 40 which is generally aimed at the mounting stage irrespective of the orientation of the mounting stage 10 or the orientation of the rotating arm 30. The sensor system can be attached at a point of the rotating arm, for example, distal from the mounting stage at the far end of the rotating arm. It is understood that the first axis 15 can be vertical and the second axis 35 can be horizontal. It is obvious that, while the mounting stage is intended for supporting a light source and the rotating arm is intended for supporting a sensor system, the opposite is equally possible.

By adjusting the first and the second angle, the sensor system 40 can be positioned at a desired point on the surface of an imaginary sphere 50. The sphere is centered at the point of intersection 60 of the first axis 15 and second axis 35 which can be chosen as the center of a coordinate system. Spherical coordinates (r,φ,θ) may be used to adequately describe the position of the sensor system relative to the center of the coordinate system. It is noted that the coordinate system may be centered at another point and that other coordinate systems, for example, Cartesian or cylindrical coordinate systems, may be used to specify the relative position of the sensor system to the light source, for example. In an embodiment, the shape, extension and/or orientation of the light source can be optionally recorded and used, for example, for certain near-field analysis of the radiation characteristics of the light source.

In an embodiment of the invention, a goniometer with an additional one or more degrees of freedom can be used. Such a goniometer may provide for more versatile relative positioning of the light source and the sensor system. This additional one or more degrees of freedom may affect data analysis and the computational effort required to process the acquired light source characteristic data as described further below. For example, the mounting stage of the goniometer can also be transversally adjustable along at least one coordinate of a Cartesian coordinate system. For example, the mounting stage can further include a three-axis micro-positioning translation stage that allows the light source to be precisely positioned with respect to the intersection of the first axis of rotation and second axis of rotation. This configuration can enable a light source to be positioned such that the sensor system can be rotated relative to the light source without losing focus of a specific surface element of the light source.

### Sensor System

The sensor system configured to sample the spatial and spectral radiation characteristics of the light source, wherein the sensor system is operatively coupled to the goniometer. The sensor system comprises one or more image sensors configured to collect light source characteristic data, which is representative of the characteristics of the light source. The sensor system may further comprises one or more optical elements which can provide for the collection and/or redirection of at least a part of the radiation emitted by the light source towards the one or more image sensors.

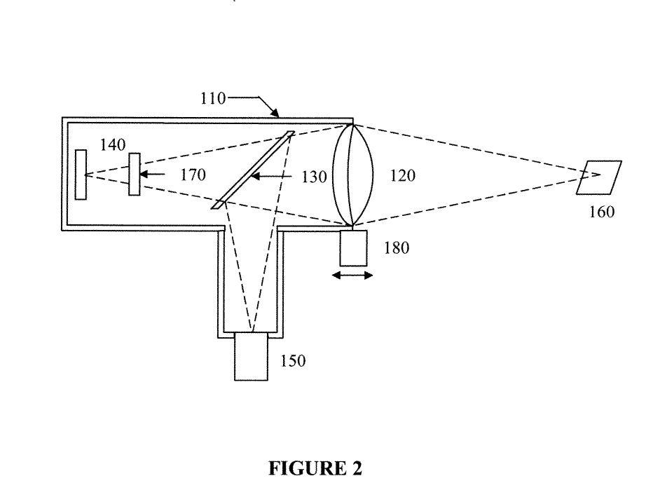

FIG. 2 illustrates a principal view of a sensor system according to an embodiment of the invention. FIG. 2 further illustrates certain details of an optical path between the light source 160 and the sensor system 110 according to this embodiment. The sensor system 110 comprises an imaging lens 120, a beam splitter 130, an image sensor 140 and, optionally, a spectroradiometer 150. The imaging lens 120 is positioned with respect to the light source 160 and the image sensor 140 to focus an image of the light source on the image sensor 140. The sensor system can optionally include a focusing mechanism 180 to adjust the distance between the imaging lens 120 and the image sensor 140. The focusing mechanism can be manually or automatically operated. It is obvious that other embodiments of the sensor system can comprise more complex optical systems which can include, for example, one or more additional refractive optical elements.

In one embodiment of the invention, a fraction of the light which is transmitted through imaging lens 120 can be reflected by means of a beam splitter 130. The beam splitter can redirect light to an aperture (not illustrated), for example, an entrance slit, of spectroradiometer 150. A spectroradiometer can be used to sample the spectral power distribution (SPD) is absolute terms, however if the SPD is required in relative terms a spectrometer can provide the desired information.

In another embodiment, a fibre optic cable can be positioned to receive a portion of the redirected light and guide the light to an entrance slit of a spectroradiometer. If suitably optically connected by the fibre optic cable, the spectroradiometer can be mounted on the goniometer or elsewhere. Certain effects, for example, chromatic aberration etc, which may be introduced by the fibre optic cable or other components, may be corrected by adequate calibration and subsequent data processing.

In another embodiment, a lenticular micro-lens array 170 can be coaxially interposed between imaging lens 120 and image sensor 140 in the manner described by Ng R. et al. in Light-field photography with a handheld plenoptic camera, Stanford Technical Report CTSR (February 2005), herein incorporated by reference. Consequently, the sensor system 110 can be made to simultaneously sample the light source at a number of different focal distances. The resultant increased depth-of-field can be used to achieve sufficient image resolution for radiance-field spectroradiometry when imaging, for example, small light sources such as LEDs.

In one embodiment of the invention each one of the adequately disposed microlenses of the lenticular microlens array can be associated with a respective portion of an image sensor's photosensitive elements. This configuration of the lenticular microlens array can enable the determination of the portion of the light of the total amount of light passing through the microlens array, is contributed from varying directions.

In one embodiment, digital image processing can be used to extract a series of images with different focal distances. A microlens array can consequently be used to extend the depth of field without having to work with or reduce the aperture, for example. This technique can also be used to shorten exposure times and to reduce noise.

The one or more image sensors can be, for example, a CMOS or CCD sensor or other type of image sensor as would be known by a worker skilled in the art. The image sensor can comprise one or more photosensitive elements. Many such photosensitive elements can be arranged in a linear or areal, matrix like fashion for simultaneous sensing or detection of radiation characteristics at the different positions on the image sensor.

In one embodiment, the one or more image sensors can be thermally connected to a thermoelectric cooling system (not illustrated) to improve the signal to noise ratio and to achieve dynamic ranges of 14 bit or more, for example. Uncooled CMOS or CCD area sensors may be limited to certain lower dynamic ranges and corresponding resolutions.

Embodiments of the invention can, however, optionally utilize one or more image sensors with low dynamic ranges. For example, sensor data from properly calibrated multiple exposures can be combined as described by Mitsunaga and Nayar in Radiometric self calibration, IEEE Proc. Computer Vision and Pattern Recognition, p 380-386 (1999), herein incorporated by reference. As described, radiometric self calibration can be used to compute a radiometric response function of an imaging system. The radiometric response function can be determined from a series of images of the same scene taken at different exposures. Different exposures can be obtained by changing exposure time or aperture, for example. A series of exposures characterized by different focal ratios are sufficient to recover an accurate estimate of the radiometric response function. The response function can be used to fuse the multiple low-dynamic range images into a single high-dynamic range radiance image.

In one embodiment of the invention, the sensor system further comprises a pre-processing system. The pre-processing system can be configured to modify the light source characteristic data prior to transmission to the control system. The pre-processing system can include one or more of amplification, filtering or the like.

### Goniometer

A goniometer is an instrument that can either measure angles or allows an object to be rotated to a precise angular position. The goniometer enables the relative positioning of the sensor system and the light source in such a manner that this relative position is a known quantity.

The goniometer is configured to move the sensor system relative to the light source, move the light source relative to the sensor system or move both the sensor system and light source relative to each other. The goniometer can comprise one or more actuators, precision motors or the like to enable the relative movement.

In one embodiment, the goniometer comprises a mounting stage and a rotating arm. The mounting stage has at least one degree of freedom including the positioning at a desired first angle by rotation about a first axis. The arm has at least one degree of freedom including the positioning at a desired second angle by rotation about a second axis, wherein the first axis and the second axis are perpendicular. The light source can be coupled to the mounting stage and the sensor system can be coupled to the sensing system or vice versa.

In one embodiment of the invention, the goniometer is configured to enable the relative movement between the light source and the sensing system via three of more degrees of freedom. This configuration of the goniometer may provide for more versatile relative positioning of the light source and the sensor system. For example, in one embodiment, the mounting stage of the goniometer can also be transversally adjustable along at least one coordinate of a Cartesian coordinate system. For example, the mounting stage can further include a three-axis micro-positioning translation stage that allows the light source to be precisely positioned with respect to the intersection of the first axis of rotation and second axis of rotation. This configuration can enable a light source to be positioned such that the sensor system can be rotated relative to the light source without losing focus of a specific surface element of the light source.

### Control System

The control system is configured to control the operation of the sensor system and the sampling of the spatial and spectral radiation characteristics of the light source. The control system is further configured to control operation of the goniometer for the relative positioning of the sensor system and the light source. In one embodiment, the control system is configured to control the operating conditions of the light source.

In one embodiment of the invention, the control system is configured to perform one or more analyses of the light source characteristic data collected by the sensor system. In another embodiment, the control system is operatively coupled to an analysis system which is configured to analyse the light source characteristic data.

The control system can comprise one or more of a variety of computing devices, microprocessors or microcontrollers including central processing units (CPUs). The control system comprises suitable interfaces for performing functions such as data acquisition, data analysis and control signal generation for controlling the operation the sensor system and the goniometer, for example. In one embodiment, the control system is configured to generate control signals for controlling the operation of the light source. A worker skilled in the art would readily understand the format of computing devices that can be used within the apparatus of the invention.

The control system can be operatively coupled to a memory device. For example, the memory device can be integrated into the control system or it can be a memory device connected to the control system via a suitable communication link. In one embodiment, the control system can store the required voltage and/or current magnitudes of previously determined drive voltages and/or currents in the memory device for subsequent use during operation of the apparatus. The memory device can be configured as an electronically erasable programmable read only memory (EEPROM), electronically programmable read only memory (EPROM), non-volatile random access memory (NVRAM), read-only memory (ROM), programmable read-only memory (PROM), flash memory or any other non-volatile memory for storing data. The memory can be used to store data and control instructions, for example, program code, software, microcode or firmware, for monitoring or controlling any devices which are coupled to the control system and which can be provided for execution or processing by the CPU.

In one embodiment of the present invention, the control system comprises a plurality of computing devices wherein a specific computing device is configured to control the operation of specific components of the apparatus. This computing system can be a master-slave configuration, wherein a master computing system can be used to control the slave computing devices which operate the specific functions or the apparatus, as would be readily understood by a worker skilled in the art.

### Data Acquisition Method

The acquisition of light source characteristic data substantially involves the relative positioning of the light source and the sensor system, and the collection of light source characteristic data which is at least in part indicative of the spatial and spectral characteristics of the light source This light source characteristic data can be collected for a plurality of relative positions, which can provide for the development of a representation of the light source characteristics, for example in the form of a radiation model.

According to one embodiment of the present invention, data acquisition can be performed in the following manner. Before acquiring any light source characteristic data the light source can be disposed on the mounting stage and appropriately adjusted to determine its position relative to the sensor system. After proper calibration, the distance to the sensor system can be manually or optionally automatically set or measured. The control system can then position the goniometer in a number of configurations to investigate the light source from different angles and optionally also from different distances. Each configuration defines a relative distance and orientation between the light source and the sensor system which can be expressed in spherical coordinates (rᵢ, φᵢ, θᵢ). Depending on the type of investigation, it may not be necessary to change rᵢ once the apparatus and all other components are properly set up.

In one embodiment, the spatial and spectral radiation characteristics of a light source under operating conditions can be initially sampled at a finite number of orientations with coordinates (φᵢ, θᵢ) (for nominally constant rᵢ) with i ε{1 . . . N}, for example. The spatial and spectral radiation characteristics of the light source under operating conditions at different coordinates can be recorded and their variations determined by the control system. Depending on the nature of the variations of the spatial and spectral radiation characteristics and the desired accuracy, it can be sufficient to only acquire data at a finite number of predetermined coordinates.

If for example, the variations in the radiation characteristics between initial relative orientations of the light source and sensor system are undesirably high, further light source characteristic data can be acquired at additional orientations with respective coordinates. Variations can be quantified in a number of different ways, for example, by determining certain gradients, curvatures or other figures that can be used to express the extent of variations between the discretely sampled relative positions of the light source and sensor system. It is noted that these variations determine the accuracy of inferred light source characteristic data for orientations which have not been directly measured.

In one embodiment, inferred light source characteristic data can be determined using various interpolation techniques. The overall accuracy of a radiation modeling process determines the usefulness of radiation model data and a different predetermined minimum accuracies may be required depending on the use of the radiation model data generated from the light source characteristic data. For example, radiation models that are used for the purpose of designing an optical projection system may require higher accuracy and therefore denser sampling than those that are used for a simple flashlight application.

In one embodiment, the control system can be configured to automatically determine coordinates of additional orientations, wherein these additional orientation coordinates can be used for controlling the goniometer in order that the light source characteristic data at these additional orientations can be acquired. In one embodiment of the invention, the control system can provide control signals to the goniometer in order that the light source and sensor system assumes the different additional refined relative orientations in a sequential, rotational, translational or random sequence irrespective of the iteration or recursion level.

In one embodiment of the invention, coordinates for additional refined relative orientations of the light source and sensor system can be generated by iterative or recursive processes, for example. It is understood that such a process can be terminated, for example, at a certain level of recursion or when the variations in the light source characteristic data, or the spatial or spectral radiation characteristics, become sufficiently small. It is also understood that the identification of additional refined orientations can be denser in directions where the spatial or spectral radiation characteristics change more rapidly.

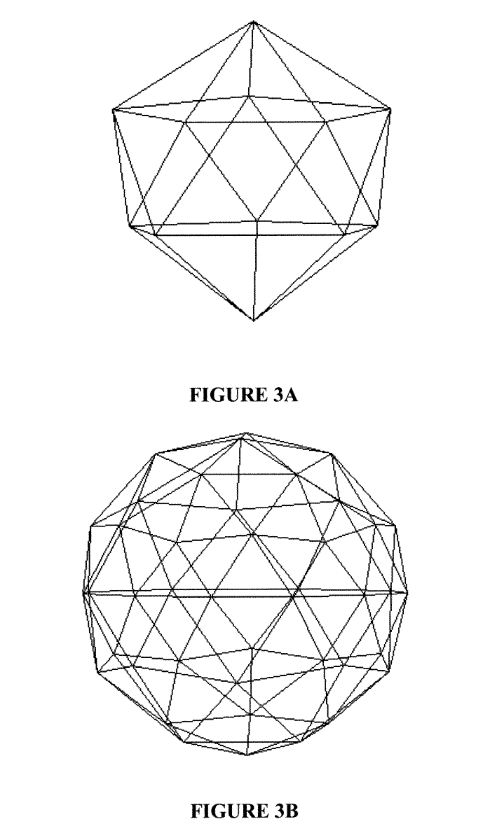

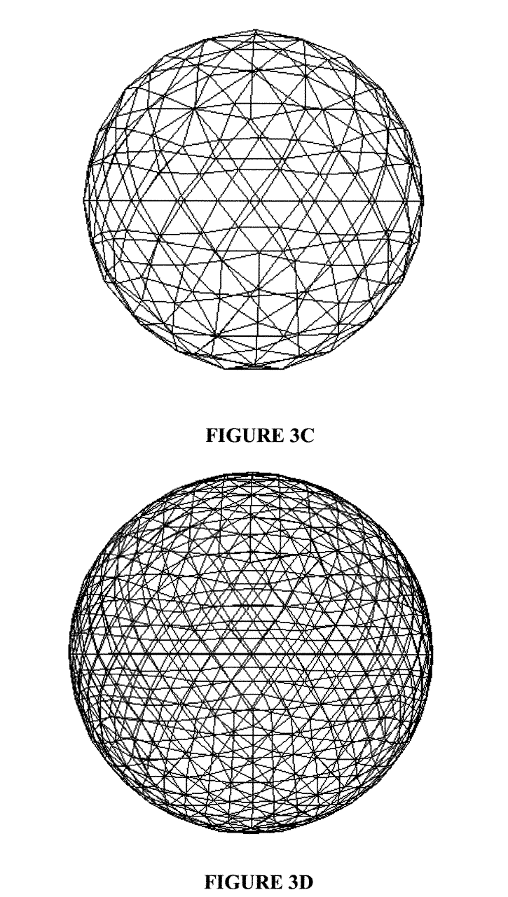

For example, FIG. 3A illustrates vertices of an icosahedron which may be used to define a set of initial coordinates for the above sampling. Other Platonic solid or convex polyhedra can equally well be used to define a set of initial coordinates. The vertices of an icosahedron provide a set of coordinates which can be used to generate a denser distribution of vertices.

In one embodiment of the invention, a method for recursively subdividing a surface triangle into four new triangles whose vertices are also coincident with the surface of the inscribing sphere can be used. The midpoints of the triangle edges can be radially projected onto the surface of the inscribing sphere and the so determined points can be reconnected with a triangular mesh. FIGS. 3B, 3C and 3D illustrate outlines of resulting first, second and third generation polyhedra, respectively, which have been generated in this manner. These polyhedra are descendents of the initial icosahedron illustrated in FIG. 3A wherein each facet or surface element, has been refined once, twice or thrice, respectively. It is also noted that it may be sufficient to generate additional sampling coordinates only for vertices with undesirably high variations in light source characteristic data but not for all other vertices or facets. Therefore, different facets may be the result of different numbers of refinement cycles. In one embodiment, these calculated vertices can be used to define additional coordinates for the relative positioning of the light source and the sensor system by the goniometer.

The control system can be configured to sample the spatial and spectral radiation characteristics at a number of orientations. In one embodiment, the orientations and the number of orientations can be predetermined or determined by user interaction at the time of data acquisition. In another embodiment, the orientations can be randomly chosen from a number of directions or distances.

For example, at each position (φᵢ, θᵢ) a digital image, which is indicative of the light source characteristic data, is captured with the image sensor or optionally a spectral power distribution can be acquired with spectroradiometer if the apparatus is appropriately configured.

In one embodiment, if the dynamic range of the image sensor is too small, for example below 14 bits, two or more images can be captured at different exposures. The two or more images can subsequently be calibrated and combined to achieve the desired dynamic range as indicated above.

The characteristics of the imaging sensor and the associated optical and electronic processing subsystems can determine the amount of required post-processing or data analysis of the light source characteristic data. Post-processing of the acquired digital images can be required in order to be able to determine the incident radiant flux that originates from a surface element of the light source or a surface element of a suitably chosen geometrical figure inscribing the light source which corresponds to the light source characteristic data acquired for each of the one or more photosensitive elements of the image sensor.

In one embodiment, the post-processing can account for one or more of dark field bias, lens vignetting, nonlinear radiometric response functions, spectral responsively of the imaging sensor, spectral transmittance characteristics of lens, beam splitter, optional lenticular microlens array and the like. Consequently, light source characteristic data acquired per photosensitive element can be processed into absolute values of; for example, luminance or radiance.

In one embodiment, post-processing includes digital refocusing when the depth of field required, for example, for imaging a planar LED die when viewed obliquely, exceeds the depth of field of the digital image. For example, if the sensor system includes lenticular microlens array, the data collected by the image sensor can be processed into a series of images with different focal distances using the method cited above. Alternatively, a series of digital images at different focal distances can be captured at a single (φᵢ, θᵢ) and the series of images can be processed into a new image. Each pixel, which is representative of the information collected by a single photosensitive element, in the new image can then be selected to be the one pixel that has the highest contrast among all the corresponding pixels in the series of images. The corresponding pixels can be all those pixels which originate from the same photosensitive element i.e. which have the same coordinates in the image. Different ways to determine contrast are widely known in the art. Moreover, the sensor system can comprise an optional aperture or aperture system (not illustrated) to be able to control the depth-of-field.

In one embodiment, the control system can determine when to stop the acquisition of spatial and spectral radiation characteristics by processing the acquired image data. For example, if the differences between the image data at triplets of neighboring orientations {(φᵢ, θᵢ), (φⱼ, θⱼ), (φₖ, θₖ)} exceed a defined threshold, then the respective triangle can be subdivided into three new triangles and new image data can be captured at the four new points. The process of, for example, triangle division can be continued recursively until the differences no longer exceed a predefined threshold or a predetermined maximum recursion depth has been reached. As previously discussed, the facets can have other than triangular shapes and consequently different numbers of neighboring orientations may need to be considered during the division process. In addition, there are a plurality of measures for quantifying the differences between the image data of neighboring orientations.

### Data Storage

The light source characteristic data can be saved in a variety of different ways. It can be directly saved in raw format or processed before saving it along with important parameters such as operating conditions of the light source or respective configurations {(φᵢ, θᵢ)}, SPD and alignment of the light source, for example.

In one embodiment, upon completion of the image capture by a image sensor, the digital image of the light source characteristic data may be compressed to reduce memory usage requirements. Compression techniques can be selected from a number of lossless entropy encoding or lossy encoding schemes or the like.

In one embodiment, the light source characteristic data or captured digital image can be encoded to save memory. There are many encoding schemes widely known in the art. Many efficient encoding schemes are wavelet based. For example, in one embodiment, the image encoding can be a non-standard Haar wavelet-decomposition as described by I. Ashdown in Making near-field photometry practical, Journal of the IES 27(1), pp 67-79 (1998), herein incorporated by reference. It is understood that while other image compression algorithms can offer higher compression ratios, the Haar transform is computationally efficient. The spectral power distribution (SPD) can be encoded using a linear combination of orthogonal basis functions, for example as described by W. Xiong and B. Funt in Independent component analysis and nonnegative linear model analysis of illuminant and reflectance spectra, Proc 10^{th} Congress of the International Colour Association, Granada Spain (2005), herein incorporated by reference.

In one embodiment of the invention, large sets of digital images which represent the light source characteristic data can be represented as volumetric image data which can be encoded using, for example, a lossy image 3D/2D multidimensional layered zero coding (MLZC) algorithm as described by G. Menegaz and J. P. Thiran in 3D encoding/2D encoding of medical data, IEEE Trans. Medical Imaging 22(3) pp 424-440, (2003). In addition there are other lossy and lossless encoding methods which can offer adequate fast restoration of individual images. Some methods can take advantage of the spatial correlations which are inherent in images showing an object from different observation angles. Other adequate encoding schemes are widely known in the art.

As described above, the acquired light source characteristic data can include information about the orientation of the light source. This information may be necessary to properly define anisotropic spatial radiation characteristics. In one embodiment, acquired image data can be complemented with information about the extent, position and alignment of the light-emitting surfaces of the light source. This information may be obtained from data sheets or by using dense disparity map estimation techniques such as described by T. Scharstein and R. Szeliski in A taxonomy and evaluation of dense two-frame stereo correspondence algorithms, Microsoft Research Technical Report MSR-TR-2001-81 (2001), herein incorporated by reference. Dense disparity map estimation techniques can be used in the reconstruction of three dimensional structural models of objects from photographic images of the objects which are taken from two or more positions. The structural models can be used to characterize the geometry and orientation of the objects just as if measuring them manually.

### Data Analysis

In one embodiment, the acquired data including the set of images, accompanying relative SPDs etc can be transformed into a sparse set of samples of a type of plenoptic function called the four-dimensional spectral radiance field. The spectral radiance field can be used with a number of optical design and analysis tools such as TracePro® from Lambda Research (Littleton, Mass., USA), for example. Optical design and analysis tools can be employed in the design of optical systems for luminaires such as automotive headlights or video projectors, for example. Such tools can also be used to design diffractive optical elements for use with LED dies.

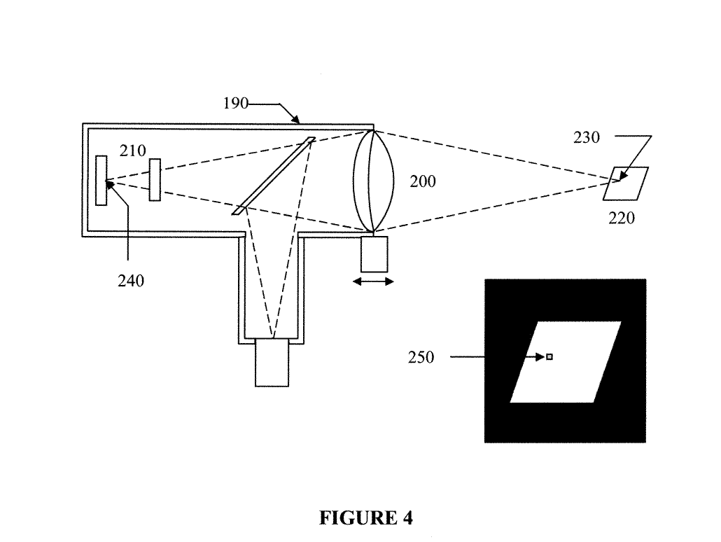

FIG. 4 is used to schematically illustrate the principle of radiance determination according to one embodiment of the invention. As illustrated a sensor system 190 comprises an imaging lens 200 and an image sensor 210. Imaging lens 200 can focus an image of light source 220 onto image sensor 210. Photosensitive element 240 is exposed to light emitted in any direction from point 230 that is imaged by the sensor system onto photosensitive element 240 of the image sensor 210. Provided that its sensitivity is non-directional, photosensitive element 240 provides a measure of the integrated radiance for those directions. The respective measure is expressed in corresponding pixel 250 of the captured image. If image sensor 210 has sufficiently high resolution or if its photosensitive elements have highly directional sensitivity, the integration effect can be neglected for practical purposes and the radiance of point 230 can be directly mapped to the irradiance of photosensitive element 240 because of Helmholtz' reciprocity law. Images of light source 220 from different observation angles can therefore provide the radiance of point 230 in different directions. When the emitted light propagates in non-interacting media, the radiance of point 230 is invariant under translations along the direction of the propagation. Hence a measured radiance can be mapped back or projected forward anywhere along the corresponding ray of light without further processing.

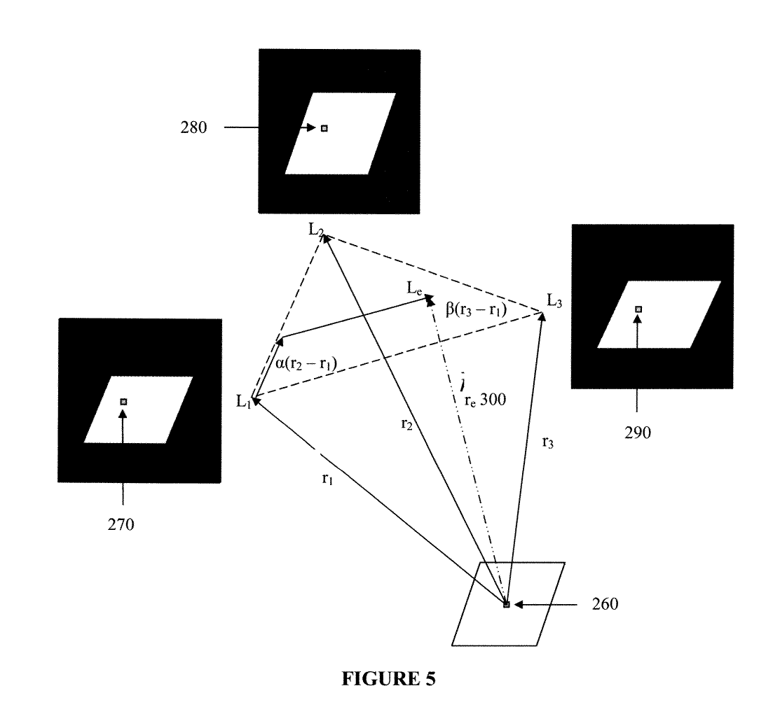

FIG. 5 schematically illustrates a method of radiance interpolation using three different images of a light source from three different directions or positions according to one embodiment of the invention. A surface element 260 of the light source is imaged from three different directions or positions \vec{r}₁, \vec{r}₂ and \vec{r}₃. Three separate rays are traced from surface element 260 which correspond to pixels 270, 280, and 290 with radiance values L₁, L₂ and L₃. The radiance for an arbitrary ray 300 originating from surface element 260 along any direction \vec{r}ₑ that intersects the basis of the pyramid defined by \vec{r}₁, \vec{r}₂ and \vec{r}₃ can be determined by linearly interpolating L₁, L₂ and L₃. This can also be achieved in any direction (σ, ω) for any such position \vec{r}ₑ using a bilinear interpolation based on re. For example, in one embodiment of the invention, the bilinear interpolation equation can be expressed as follows:

\vec{L}ₑ(\vec{r}ₑ,σ,ω)=(1+α)\vec{L}₁(\vec{r}₁,σ,ω)+(1−α+β)\vec{L}₂(\vec{r}₂,σ,ω)−β\vec{L}₃(\vec{r}₃,σ,ω) (1)

wherein

$${\overline{L}}_{i} ( {\overline{r}}_{i} , σ , ω ) = {L}_{i} ( {\overline{r}}_{i} , σ , ω ) \frac{{\overline{r}}_{i}}{‖ {\overline{r}}_{i} ‖} ,$$

and (1) can be solved for the three unknown variables α, β and Lₑ(\vec{r}ₑ,σ,ω), as disclosed in Ashdown, I. A near-field goniospectroradiometer for LED measurements, Proc. International Optical Design Conference 2006, SPIE Vol. 6342, 634215, herein incorporated by reference.

In one embodiment, a bilinear interpolation can similarly be used to interpolate SPD values ρ(\vec{r},σ,ω,λ) for any \vec{r}ₑ by replacing the \vec{L}ᵢ(\vec{r}ᵢ,σ,ω) above with \vec{ρ}ᵢ(\vec{r}ᵢ,σ,ω,λ) which can be defined as follows:

$${\overline{ρ}}_{i} ( {\overline{r}}_{i} , σ , ω , λ ) = {ρ}_{i} ( {\overline{r}}_{i} , σ , ω , λ ) \frac{{\overline{r}}_{i}}{‖ {\overline{r}}_{i} ‖} \qquad ( 2 )$$

wherein ρ(\vec{r},σ,ω,λ) represents the SPD at \vec{r} and wavelength λ in the direction defined by (σ,ω) and solving the bilinear interpolation equation (2) for α, β and ρₑ(\vec{r}ₑ,σ,ω,λ).

The foregoing method can be used to determine, for example, radiance or luminance, at a point which may be required for further processing by, for example, an optical design tool such as radiosity or ray tracing programs.

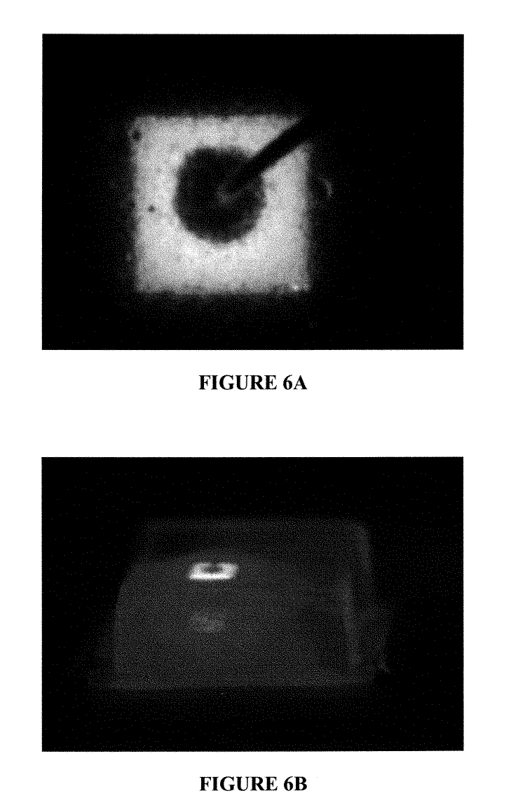

FIG. 6A illustrates an example photograph of a light-emitting diode (LED) die under operating conditions which was taken with an apparatus according to the invention. FIG. 6B illustrates a photograph of an encapsulated LED die under operating conditions which was taken with an apparatus according to the invention.

It is understood that the foregoing embodiments of the invention are exemplary and can be varied in many ways. Such present or future variations are not to be regarded as a departure from the spirit and scope of the invention, and all such modifications as would be readily understood to one skilled in the art are intended to be included within the scope of the following claims.

We claim:

1. An apparatus for sampling light source characteristic data, the apparatus comprising:
a) a sensor system including one or more image sensors configured to collect light source characteristic data;
b) a goniometer operatively coupled to the sensor system and the light source, the goniometer configured to control relative position between the sensor system and light source, the goniometer comprising two or more degrees of freedom for relative positioning of the sensor system and the light source; and
c) a control system configured to control operation of the goniometer to control the relative position between the light source and the sensor system, the control system further configured to control the sensor system for acquisition of the spectral radiation characteristics, wherein the control system captures light source characteristic data which is indicative of spatial and spectral characteristic of the light source as defined by the relative position of the light source and the sensor system.

2. The apparatus according to claim 1, wherein the goniometer comprises a mounting stage having one degree of freedom and a rotating arm having one degree of freedom.

3. The apparatus according to claim 2, wherein the light source is operatively coupled to the mounting stage and the sensor system is operatively coupled to the rotating arm.

4. The apparatus according to claim 2, wherein the light source is operatively coupled to the rotating arm and the sensor system is operatively coupled to the mounting stage.

5. The apparatus according to claim 2, wherein the mounting stage has a first rotational degree of freedom and the rotating arm has a second rotational degree of freedom, wherein the first rotational degree of freedom and the second rotational degree of freedom are perpendicular.

6. The apparatus according to claim 5, wherein the mounting stage further comprises a first translational degree of freedom.

7. The apparatus according to claim 1, wherein each of the one or more image sensors comprises a plurality of photosensitive elements.

8. The apparatus according to claim 1, wherein light source characteristic data captured by a particular photosensitive element is indicative of a predetermined location on the light source.

9. The apparatus according to claim 1, wherein the sensor system comprises a spectroradiometer.

10. The apparatus according to claim 1, wherein the sensor system is configured to pre-process the light source characteristic data.

11. The apparatus according to claim 10, wherein pre-processing includes amplification or filtering or both.

12. The apparatus according to claim 1, wherein the control system is configured to compress the light source characteristic data using a predetermined compression technique.

13. A method for sampling spatial and spectral radiation characteristics of a light source, the method comprising the steps of:
a) disposing and aligning the light source;
b) positioning a sensor system relative to the light source thereby defining a first relative position and orientation of the sensor system to the light source;
c) acquiring first light source characteristic data from the sensor system, the first light source characteristic data indicative of the spatial and spectral radiation characteristics of the light source in the first relative position;
d) recording the first light source characteristic data and the first relative position and orientation,
e) determining a second relative position and orientation of the sensor system to the light source,
i) positioning the sensor system and the light source at the second relative position and orientation of the sensor system to the light source;
g) acquiring second light source characteristic data from the sensor system, the second light source characteristic data indicative of the spatial and spectral radiation characteristics of the light source in the first relative position;
h) recording the second light source characteristic data and the second relative position and orientation.

14. The method according to claim 13, wherein the second relative position and orientation is selected from one or more predetermined relative positions and orientations.

15. The method according to claim 13, wherein a third relative position and orientation is determined by interpolation between two or more previously recorded relative positions and orientations.

16. The method according to claim 13, wherein a third relative position and orientation is determined by interpolation, if spatial and spectral radiation characteristics at previously recorded relative positions and orientations meet a predetermined condition.

17. The method according to claim 16, wherein the predetermined condition is a curvature defined by the spectral radiation characteristics at previously recorded relative positions and orientations exceeds a predetermined threshold.

18. The method according to claim 16, wherein the predetermined condition is a maximum local gradient defined by the spectral radiation characteristics at previously recorded relative positions and orientations exceeds a predetermined threshold.

19. The method according to claim 15, wherein the interpolation is linear.

20. The method according to claim 15, wherein the interpolation comprises refinement of vertices of a polyhedra on an inscribing sphere.

21. The method according to claim 13, additionally comprising inferring spatial and spectral radiation characteristics of the light source at a desired relative position and orientation based upon previously recorded spatial and spectral radiation characteristics and corresponding relative positions and orientations.

22. The method according to claim 21, wherein the inferring comprises linear interpolation.

23. The method according to claim 13, further comprising the step of compressing the first light source characteristic data prior and second light source characteristic data prior to recording thereof.

24. The method according to claim 13, further comprising the step of determining a plenoptic function based on collected light source characteristic data.

25. The method according to claim 24, wherein the step of determining the plenoptic function is further based on interpolated light source characteristic data determined from the collected light source characteristic data.
